(19) United States
(12) Patent Application Publication
(10) Pub. No.: US 2016/0132813 A1
(43) Pub. Date: May 12, 2016

(54) SYSTEMS FOR MANAGING QUALITY ASSURANCE OF WORK ASSIGNMENTS

(71) Applicant: BANK OF AMERICA CORPORATION, Charlotte, NC (US)

(72) Inventors: Gopala Krishna Meher Kala, Hyderabad (IN); Sarvesh Neelakanta Subramani, Mumbai (IN); Sreedhar Reddy Chilumula, Hyderabad (IN); Mohit Kapoor, Chandha Nagar (IN); Navneesh Sarin, Gurgaon (IN); Dinesh Narain, New Delhi (IN)

(21) Appl. No.: 14/535,723

(22) Filed: Nov. 7, 2014

(51) Int. Cl. G06Q 10/06

(52) U.S. Cl. CPC G06Q 10/06395

(57) ABSTRACT

Systems, apparatus, and computer program products provide for a comprehensive quality assurance platform for automatically assessing the quality of work performance of associates. The described quality assurance system/module that can be implemented in conjunction with the work allocation system described herein or the system can operate as a standalone quality assurance system/module. The quality assurance system provides for automated collection and tracking of quality metrics and automated quality calibrations (i.e., automated and random selection of work assignment/transactions for comparison to standards). Additionally, the quality assurance system provides for validating the quality assurance work by random sampling and quality assurance assessment of the auditor's work and an associate improvement plan, whereby quality assurance metrics may be systematically adjusted and/or sampling sizes increased for associates with quality scores that dictate a need for improvement.

### FIELD

In general, embodiments of the invention relate to managing quality assurance of work assignments and, more particularly, an automated system for assessing the quality of work assignments, performing calibration of work assignments, auditing the quality assurance process and implementing corrective action/improvement plans for the associates performing the work assignments.

### BACKGROUND

In large enterprise businesses, such as a financial institution having offices and branches located worldwide, work allocation becomes a taunting task because of the difference in business practices amongst of lines-of-business, work units and the like spread across world-wide geographies. In addition assuring the quality of the work being allocated in terms of repeatability and reproducibility becomes problematic.

In many instances, assuring the quality of work assignments may be handled with a high amount of manual intervention, such as manual maintenance of data, manual distribution and tracking of work by the work teams/entities and the like. In addition, collation and reporting across different work units, job functions and geographies becomes problematic. Such manual processes are prone to human error, for example, data updates may fail to be performed, reporting may be inaccurate and the like. In addition, archiving of quality assurance data is relegated to tracking previous data inflow, such as, back tracking through emails, different inbound data source and the like. Moreover, current quality assurance processing provides for limited or, in some instances, no real-time means for measuring work performance or assessing quality to ensure process capability.

Therefore, a need exists to develop systems, apparatus, computer program products, methods and the like that would provide for automated quality assurance of work assignments, such as handing customer financial transactions within a financial institution or the like. The desired systems may be used in conjunction with a comprehensive automated system for work assignment, allocation and tracking, or the desired system may be configured as a stand-alone system. The desired system should provide for defining work performance metrics on a per-work assignment basis (i.e., per work entity/line-of-business, per work queue/work template, or the like). In addition, the desired system should provide for automatic sampling of transactions within work assignments for the purpose of calibrating work processed to known standards. Moreover, the desired systems should provide automatically assessing the quality of the quality assurance process (i.e., auditing the auditor) and automated corrective action/improvement plans for those associates exhibiting unacceptable quality in the performance of a work assignment.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for a comprehensive quality assurance platform for automatically assessing the quality of work performance of associates (i.e., those who perform the work). As such, present embodiments significantly increase repeatability and reproducibility into the overall performance of work assignments. The described quality assurance system/module that can be implemented in conjunction with the work allocation system described herein or the system can operate as a standalone quality assurance system/module. In addition, the quality assurance system provides for automated collection and tracking of quality metrics and automated quality calibrations (i.e., automated and random selection of work assignment/transactions for comparison to standards). Additionally, the quality assurance system provides for validating the quality assurance work by random sampling and quality assurance processing of the auditor's work (i.e., auditing the auditors). Moreover, the quality assurance aspects of the present invention provide for an associate improvement plan, whereby quality assurance metrics may be systematically adjusted and/or sampling sizes increased for associates with quality scores that dictate a need for improvement. Moreover, present embodiments of the invention, allow users to perform real-time quality monitoring of the work as it being performed.

An apparatus for quality assurance assessment of a work process/assignment defines first embodiments of the invention. The apparatus includes a computing platform having a memory and at least one processor in communication with the memory. The apparatus further includes a work process quality assurance module that is stored in the memory and executable by the processor. The module includes a work transaction quality assurance (QA) sampling sub-module. The work transaction QA sampling sub-module is configured to receive first user-inputs that define a sample size for each of a plurality of sampling constraints and receive second user-inputs that select a time and date range for sampling completed work transactions from the work process. Further, the sub-module is configured to receive third user-inputs that select one or more work queues from the work process to be sampled and receive a fourth user-input that selects a sampling constraint from amongst the plurality of sampling constraints. In addition, the sub-module is configured to receive a fifth user-input that is configured to automatically and randomly determine samples for quality assurance assessment in accordance with (i) the selected time and date range, (ii) the selected work queues, (iii) the selected sampling constraint and (iv) the selected sample size associated with the selected sampling constraint.

In specific embodiments of the apparatus, the work transaction QA sampling sub-module is further configured to receive first user-inputs that define a sample size for each of the plurality of sampling constraints, wherein the sampling constraints include (i) an overall population of associates assigned to a work process, (ii) each associate for each work queue worked by a corresponding associate, (iii) each individual queue in the work process, and (iv) each individual associate assigned to the work process.

In other specific embodiments of the apparatus, the work transaction QA sampling sub-module is further configured to receive a sixth user-input that is configured to automatically and randomly allocate the determined samples to a general quality assurance queue.

Additionally, in other specific embodiments of the apparatus the work transaction QA sampling sub-module is further configured to receive first user-inputs that define a sample size for each of a plurality of sampling constraints, such that each sample size may be one of a percentage or a numerical value.

In still further specific embodiments of the apparatus the work process quality assurance module further includes an associate calibration sub-module configured to receive a sixth user-input that defines a number of days between calibration trials. In such embodiments of the apparatus, the associate calibration sub-module may be further configured to, based on the number of days between calibration trials expiring for an associate, automatically, and without knowledge of the associate, allocate a transaction performed by the associate to a general calibration queue in which the transaction is compared to a calibration standard.

Moreover, in further embodiments of the apparatus the work process quality assurance module further includes an auditor quality assurance sub-module that is configured to receive a sixth user-input that defines an auditor-specific sample size of the work process transactions that undergo quality assurance assessment by the auditor.

Additionally, in specific embodiments of the apparatus, the work process quality assurance module further includes an associate improvement plan sub-module that is configured to receive sixth user-inputs that define, for an associate requiring process improvement, target values for (i) an overall quality score and (ii) individual work process parameters and an additional sample size of work process transactions performed by the associate that are to be quality assurance sampled. While in other specific embodiments of the apparatus, the work process quality assurance module further includes a certification sub-module that is configured to receive a sixth user-input that defines a process certification cycle for a specified work process.

A computer program product including a non-transitory computer-readable medium defines second embodiments of the invention. The computer-readable medium includes a first set of codes for causing a computer to receive first user-inputs that define a sample size for each of a plurality of sampling constraints and a second set of codes for causing a computer to receive second user-inputs that select a time and date range for sampling completed work transactions from the work process. The computer-readable medium further includes a third set of codes for causing a computer to receive third user-inputs that select one or more work queues from the work process to be sampled and a fourth set of codes for causing a computer to receive a fourth user-input that selects a sampling constraint from amongst the plurality of sampling constraints. In addition, the computer-readable medium includes a fifth set of codes for causing a computer to automatically and randomly determine samples for quality assurance assessment in accordance with (i) the selected time and date range, (ii) the selected work queues, (iii) the selected sampling constraint and (iv) the selected sample size associated with the selected sampling constraint.

In specific embodiments of the computer program product, the first set of codes is further configured to cause the computer to receive the first user-inputs that define the sample size for each of the plurality of sampling constraints, wherein the sampling constraints include (i) an overall population of associates assigned to a work process, (ii) each associate for each work queue worked by a corresponding associate, (iii) each individual queue in the work process, and (iv) each individual associate assigned to the work process.

In other specific embodiments of the computer program product, the computer-readable medium includes a sixth set of codes for causing a computer to automatically and randomly allocate the determined samples to a general quality assurance queue.

In still further specific embodiments of the computer program product, the computer-readable medium further includes a sixth set of codes for causing a computer to receive a fifth user-input that defines a number of days between calibration trials. In such embodiments of the computer program product, the computer-readable medium may further include a seventh set of codes for causing a computer to, based on the number of days between calibration trials expiring for an associate, automatically, and without knowledge of the associate, allocate a transaction performed by the associate to a general calibration queue in which the transaction is compared to a calibration standard.

Moreover, in other specific embodiments of the computer program product, the computer-readable medium further includes a sixth set of codes for causing a computer to receive a fifth user-input that defines an auditor-specific sample size of the work process transactions that undergo quality assurance assessment by the auditor. While in other specific embodiments of the computer program product, the computer-readable medium further comprises a sixth set of codes for causing a computer to receive fifth user-inputs that define, for an associate requiring process improvement, target values for (i) an overall quality score and (ii) individual work process parameters and an additional sample size of work process transactions performed by the associate that are to be quality assurance sampled. In additional specific embodiments of the computer program product, the computer-readable medium further includes a sixth set of codes for causing a computer to receive a fifth user-input that defines a process certification cycle for a specified work process.

A method for quality assurance assessment of a work process/assignment defines third embodiments of the invention. The method includes receiving (1) first user-inputs that define a sample size for each of a plurality of sampling constraints and (2) second user-inputs that select a time and date range for sampling completed work transactions from the work process. The method further includes receiving (3) third user-inputs that select one or more work queues from the work process to be sampled and receiving (4) a fourth user-input that selects a sampling constraint from amongst the plurality of sampling constraints. The method further includes automatically and randomly, determining samples for quality assurance assessment in accordance with (i) the selected time and date range, (ii) the selected work queues, (iii) the selected sampling constraint and (iv) the selected sample size associated with the selected sampling constraint.

Thus, systems, apparatus, methods, and computer program products herein described in detail below provide for a comprehensive quality assurance platform for automatically assessing the quality of work performance of associates, the system herein described in detail below for automated definition, collection and tracking of quality metrics and automated sampling of transactions within the work assignments for quality calibrations. Additionally, the quality assurance system provides for validating the quality assurance work by random sampling and quality assurance assessment of the auditor's work and an associate improvement plan, whereby quality assurance metrics may be systematically adjusted and/or sampling sizes increased for associates with quality scores that dictate a need for improvement.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for quality assurance assessment of a work process, in accordance with embodiments of the present invention;

FIG. 2 provides a more detailed block diagram of the apparatus configured for quality assurance assessment of a work process, in accordance with embodiments of the present invention;

FIG. 3 provides a flow diagram of a method for quality assurance assessment of a work process, in accordance with embodiments of the present invention;

FIG. 4 provides a block diagram of an apparatus configured for scheduling, allocating and tracking work assignments, in accordance with embodiments of the present invention;

FIG. 5 provides a more detailed block diagram of the apparatus scheduling, allocating and tracking work assignments, in accordance with embodiments of the present invention;

FIG. 6 provides a flow diagram of a method for scheduling, allocating and tracking work assignments, in accordance with embodiments of the present invention; and

FIGS. 7-29 provide examples of user-interfaces configured for scheduling, allocating, and tracking work assignments, as well as providing quality assurance of such work processes, in accordance with embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for a comprehensive quality assurance platform for automatically assessing the quality of work performance of associates. As such, present embodiments significantly increase repeatability and reproducibility into the overall performance of work assignments. The described quality assurance system/module that can be implemented in conjunction with the work allocation system described in detail herein or the system can operate as a standalone quality assurance system/module. In addition, the quality assurance system provides for automated collection and tracking of quality metrics and automated quality calibrations (i.e., automated and random selection of work assignment/transactions for comparison to standards). Additionally, the quality assurance system provides for validating the quality assurance work by random sampling and quality assurance processing of the auditor's work (i.e., auditing the auditors). Moreover, the quality assurance aspects of the present invention provide for an associate improvement plan, whereby quality assurance metrics may be systematically adjusted and/or sampling sizes increased for associates with quality scores that dictate a need for improvement.

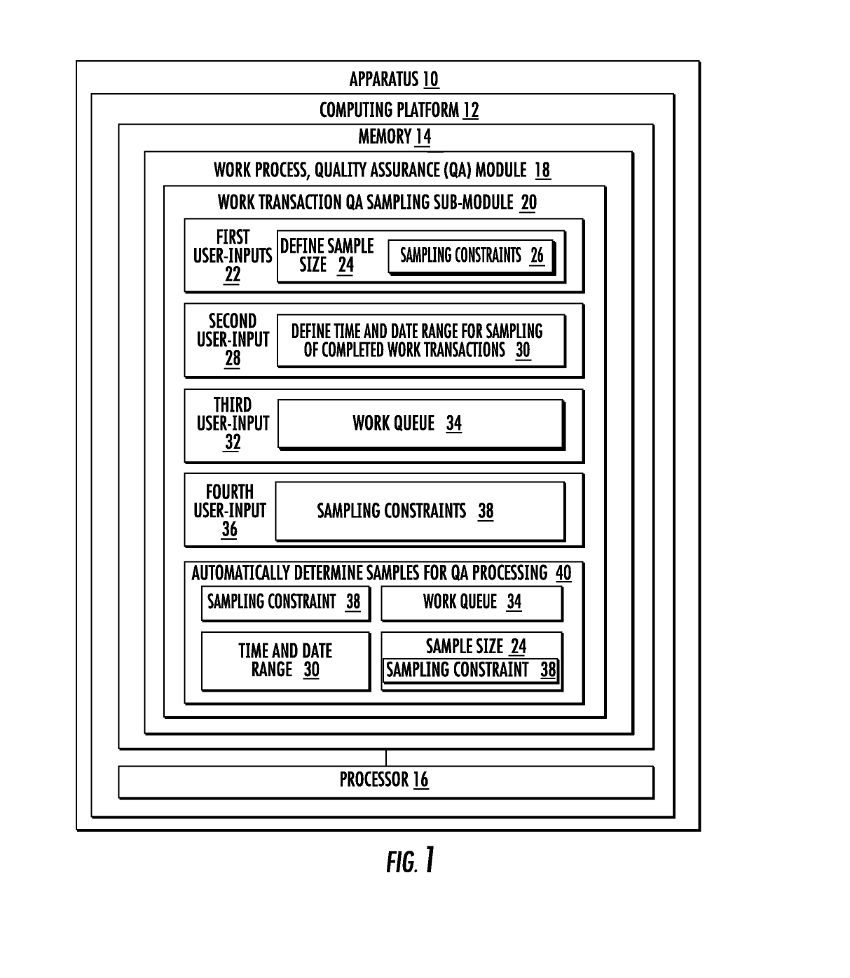

Referring to FIG. 1, a block diagram is presented of an apparatus 10 configured for quality assurance assessment of a work process, in accordance with embodiments of the present invention. The apparatus includes a computing platform 12 having a memory 14 and at least one processor 16 in communication with the memory. The apparatus 10 which may include more than one physical device or unit is operable to receive and execute modules, routines and applications, such as work process quality assurance (QA) module 18 and the like.

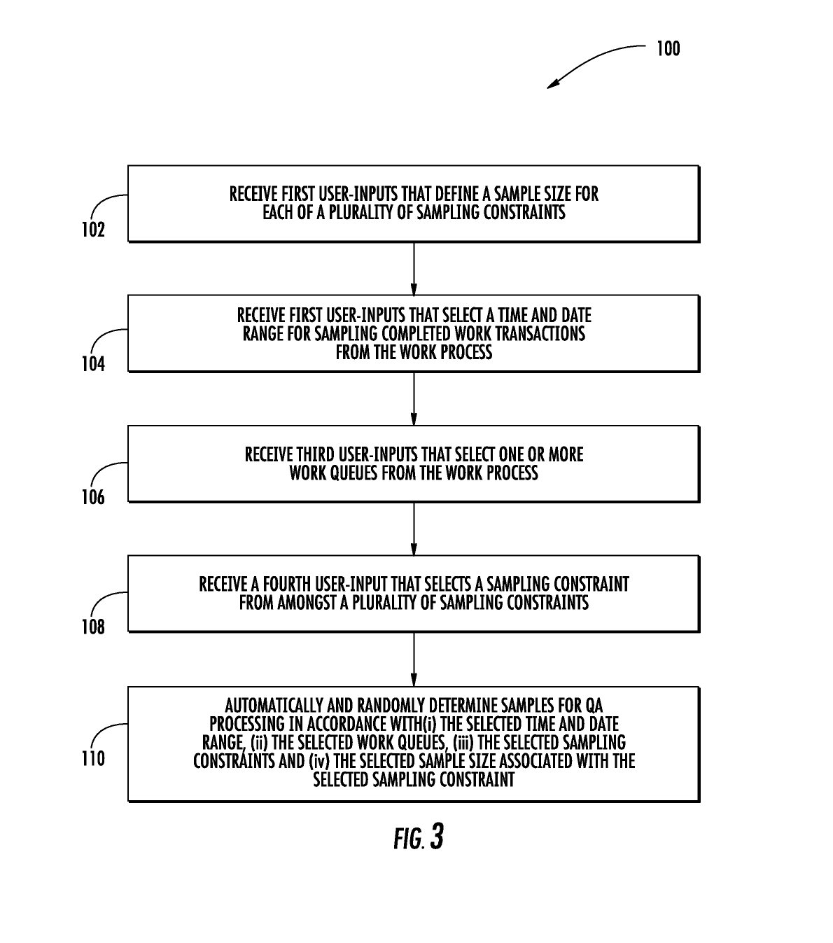

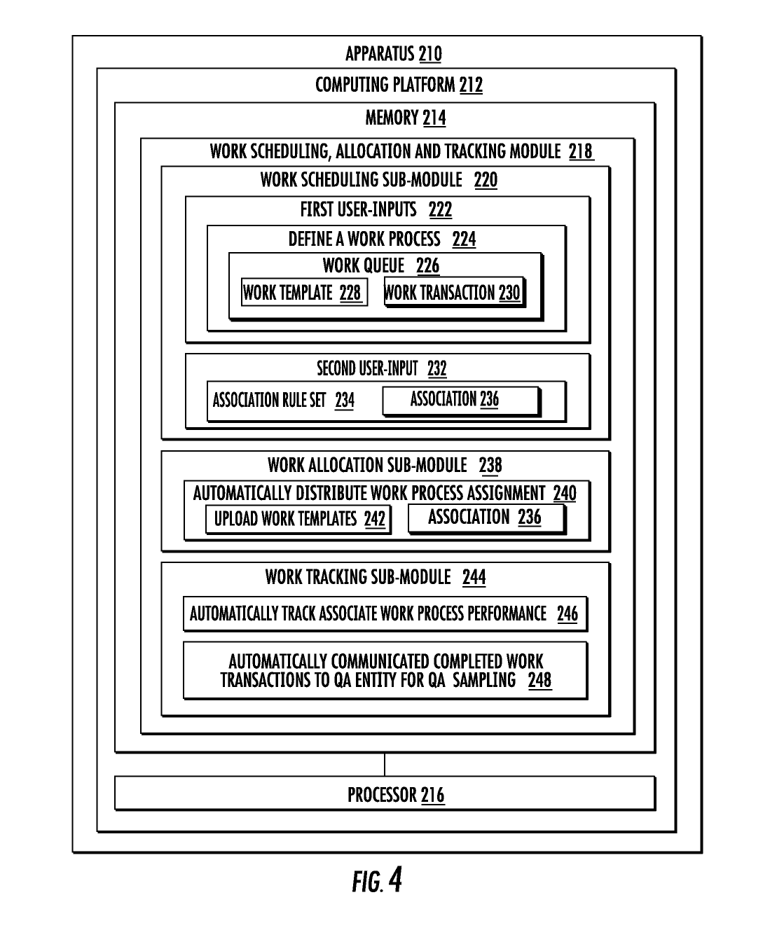

Work process quality assurance module 18 is stored in the memory 14 of apparatus 10 and is executable by the processor 16. The module 18 may be configured to work in conjunction with the work scheduling, allocation and tracking module 18 described below in FIGS. 4 and 5, or, in alternate embodiments, the module 18 may be configured as a standalone module/tool. In accordance with embodiments of the invention, the work process quality assurance module 18 provides for assessing the repeatability and reproducibility of the process through automatically tracking performance metrics and performing quality assurance assessments on samples of work assignments/transactions. Moreover, the quality assurance module 18 provides for other functionality, such as, automated calibration sampling, automated quality checks on the quality assurance functions (i.e., auditing the auditor) and implementation of associate improvement plans in the event quality scores and performance metrics dictated automated incremental calibration sampling.

Work process quality assurance module 18 includes work transaction quality assurance (QA) sampling sub-module 20 that is configured to receive QA sampling parameters and constraints, determine QA samples and automatically allocate sampled transaction to a QA queue, in accordance with embodiments of the present invention. Sub-module 20 is configured to receive first user-inputs 22 that define a QA sample size 24 for each of plurality of sampling constraints 26. The sampling constraints may be queue based on associate (i.e., individual who performs the work).

Additionally, sub-module 20 is configured to receive second user-inputs 28 that select a time and a date range 30 for sampling completed work assignments/transactions and third user-inputs 32 that select one or more work queues 34 from the work process. The selected work queues 34 are the queues from which QA samples are subsequently drawn from. In addition, sub-module 20 is configured to receive a fourth user-input 36 that selects a sampling constraint 38 from amongst the plurality of sampling constraints 26.

Work transaction quality assurance (QA) sampling sub-module 20 is further configured to automatically and randomly determine QA samples 40 for quality assurance assessment purposes in accordance with (i) the selected time and data range 30, (ii) the selected work queue(s) 34, (iii) the selected sampling constraint 38, and (iv) the selected sample size 24 associated with the selected sampling constraint 38.

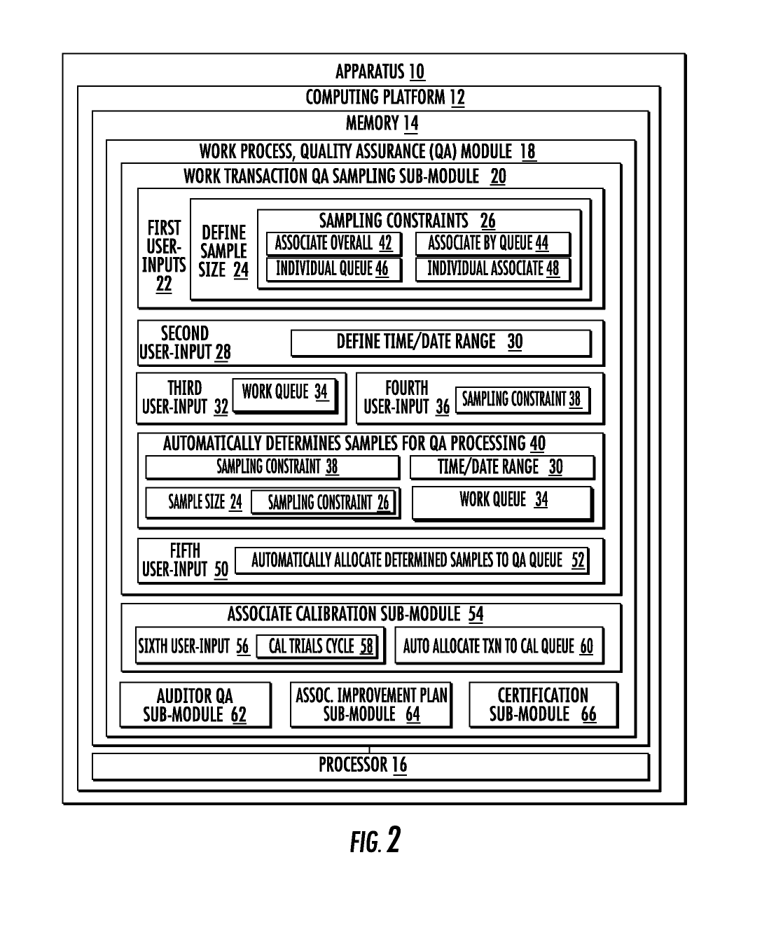

Referring to FIG. 2 a more detailed block diagram is presented of the apparatus 10, which is configured for quality assurance assessment of a work process, in accordance with embodiments of the present invention. In addition to providing greater detail, FIG. 2 highlights various alternate embodiments of the invention. The apparatus 10 may include one or more of any type of computing device. The present apparatus and methods can accordingly be performed on any form of one or more computing devices.

The apparatus 10 includes computing platform 12 that can receive and execute algorithms, such as routines, and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 2) that interfaces with any resident programs, such as work process QA module 18 and routines, sub-modules associated therewith or the like stored in the memory 14 of the apparatus 10.

Processor 16 includes various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications and exchanging data with other networked devices. For the disclosed aspects, processing subsystems of processor 16 may include any subsystem used in conjunction with work process QA module 18 and related algorithms, sub-algorithms, sub-modules thereof.

Computer platform 12 may additionally include communications module (not shown in FIG. 2) embodied in hardware, firmware, software, and combinations thereof, that enables communications among the various components of the apparatus 10, as well as between the other networked devices. Thus, communication module may include the requisite hardware, firmware, software and/or combinations thereof for establishing and maintaining a network communication connection.

As previously discussed in relation to FIG. 1, the memory 14 of apparatus 10 stores work process QA module 18 which includes work transaction quality assurance (QA) sampling sub-module 20 that is configured to receive QA sampling parameters and constraints, determine calibration samples and automatically allocate sampled transaction to a calibration queue, in accordance with embodiments of the present invention. Sub-module 20 is configured to receive first user-inputs 22 that define a QA sample size 24 for each of plurality of sampling constraints 26. The sampling constraints may include, but are not limited to, sampling per the overall associate population 42, sampling per individual associate by individual queue 44, sampling per individual queue 46 and sampling per each individual associate 48. The sampling size may be a finite numerical value or the sampling size may be defined as a percentage.

Additionally, sub-module 20 is configured to receive second user-inputs 28 that select a time and a date range 30 for sampling completed work assignments/transactions and third user-inputs 32 that select one or more work queues 34 from the work process. The selected work queues 34 are the queues from which QA samples are subsequently drawn from. In addition, sub-module 20 is configured to receive a fourth user-input 36 that selects a sampling constraint 38 from amongst the plurality of sampling constraints 26.

Work transaction quality assurance (QA) sampling sub-module 20 is further configured to automatically and randomly determine QA samples 40 for quality assurance assessment purposes in accordance with (i) the selected time and data range 30, (ii) the selected work queue(s) 34, (iii) the selected sampling constraint 26, and (iv) the selected sample size 24 associated with the selected sampling constraint 38.

In specific embodiments of the invention, the work transaction QA sampling sub-module 20 is further configured to receive a fifth user-input 50 that is configured to automatically allocate 52 the determined calibration samples to a general QA queue.

In additional embodiments of the apparatus 10, the work process QA module 18 includes associate calibration sub-module 54. Associate calibration sub-module 54 is configured to receive a sixth user-input 56 that defines the calibration trial cycle 58 (i.e., the number of days between calibration cycles). Further the associate calibration sub-module 54 is configured to, based on the defined calibration trial cycle expiring for a specific associate, automatically, and without knowledge of the associate, allocate a completed work assignment/transaction 60 performed by the associate to the general calibration queue. Work assignments/transactions residing in the calibration queue are subsequent calibrated based on comparison to a known standard work assignment/transaction.

Moreover, in further embodiments of the apparatus 10, the work process QA module 18 includes auditor QA sub-module 62 that is configured to receive user-inputs that define auditor-specific sample sizes (finite number or percentage) for the work assignments/transactions that undergo quality assurance assessment processing by the auditor (i.e., auditing the auditor). In addition, the work process QA module 18 may include associate improvement plan sub-module 64 that is configured to receive user-inputs that define, for an associate identified as requiring work process improvement, (1) target values for (i) an overall associate quality score and/or (ii) individual work process performance metrics/parameters, and (2) an additional incremental QA sample size for work assignment/transaction performed by the associate. Additionally, the work process QA module 18 may include a certification sub-module 66 that is configured to receive user-inputs that define a work process and/or work assignment certification cycle (i.e., the number of days before re-certification is required) and the requirements for notifying/alerting applicable parties (e.g., managers or the like) that re-certification is due.

FIG. 3 provides a flow diagram of a method 100 for quality assurance assessment of a work process, in accordance with embodiments of the present invention. At Event 102, first user-inputs are received that define a QA sample size, either a finite number or a percentage, for each of a plurality of QA sampling constraints. In accordance with embodiments of the present invention the QA sampling constraints may be associate/individual-based and/or queue-based. At Event 104, second user-inputs are received that select a time and date range over which completed work assignments/transactions are to be QA sampled.

At Event 106, third user-inputs are received that select one or more work queues from the work process from which QA samples are to determined and, at Event 108, a fourth user-input is received that selects a sampling constraint from amongst the plurality of sampling constraints.

At Event 110, QA samples are determined, automatically and randomly, in accordance with the selected (i) time and date range, (ii) work queue(s), (iii) sampling constraint, and (iv)sample size associated with the selected sampling constraint.

Referring to FIG. 4, a block diagram is presented of an apparatus 210 configured for scheduling, allocating and tracking work assignments, in accordance with embodiments of the present invention. The apparatus includes a computing platform 212 having a memory 214 and at least one processor 16 in communication with the memory. The apparatus 210 which may include more than one physical device or unit is operable to receive and execute modules, routines and applications, such as work scheduling, allocation and tracking module 218 and the like.

Work scheduling, allocation and tracking module 218 is stored in the memory 214 of apparatus 210 and is executable by the processor 216. The module 218 is configured to provide end-to-end work assignment (e.g., transaction) tracking, including work schedule/allocation, work processing and quality assessment of the processed work assignment. Additionally, the module 218 is configured to provide for automatic allocation of work assignments, as well as providing for a user to manually allocate work assignments.

As specific embodiments the work scheduling, allocation and tracking module 218 includes work scheduling sub-module 220 that is configured to allow a user to schedule work assignments. In this regard, sub-module 220 is configured to receive first user-inputs 222 that define a work process 224 by identifying one or more work queues 226 and, subsequently uploading a work template 228 associated with the work queue 226. Each work queue 226 comprises is a subdivision of the overall work process and includes one or more, typically a plurality of, work transactions 230 that are to be processed/conducted by individuals (e.g., associates or the like) assigned to the work queue 226. Identification of the work queue may include selecting a work queue 226 from a listing of pre-existing work queues or, alternatively, generating a new work queue. Each work queue 226 has an associated a work template 228 that provides instructions, in the form of designated fields, for processing the work transactions 230 in the associated work queue 226.

Work scheduling sub-module 220 is further configured to receive second user-inputs 232 that define an associate rule set 234 that is configured to determine a plurality of associates 236 who are assigned/allocated to the work process by granting the assigned associates access to one or more of the work queues 226. In this regard, the associate rule set 234 serves to define the criteria for the associates that will be assigned to the work process, for example, specific work transaction requirements, availability during specified days of week, work shifts and the like.

Work scheduling, allocation and tracking module 218 additionally includes work allocation sub-module 238 that is configured to allocate the work process assignments to the plurality of associates 236. In this regard, work allocation sub-module 238 is configured to automatically, in response to (i) uploading 242 the work templates 228 associated with the work queues 226 and (ii) determining the associates 236, distribute/allocate 240 work process assignments to the determined/assigned associates 236.

In addition, work scheduling, allocation and tracking module 218 additionally includes work tracking sub-module 244 that is configured to automatically (i) track associate work process performance based, at least, on the associate's productivity 246 (i.e., time to perform work transactions and the like), and (ii) communicate completed work transactions to a quality assurance entity for subsequent quality assurance sampling purposes 248 (i.e., choosing samples of completed work transactions).

Referring to FIG. 5 a more detailed block diagram is presented of the apparatus 10, which is configured for scheduling, allocating and tracking work assignments, in accordance with embodiments of the present invention. In addition to providing greater detail, FIG. 5 highlights various alternate embodiments of the invention. The apparatus 210 may include one or more of any type of computing device. The present apparatus and methods can accordingly be performed on any form of one or more computing devices.

The apparatus 210 includes computing platform 212 that can receive and execute algorithms, such as routines, and applications. Computing platform 212 includes memory 214, which may comprise volatile and non-volatile memory, such as read-only and/or random-access memory (RAM and ROM), EPROM, EEPROM, flash cards, or any memory common to computer platforms. Further, memory 214 may include one or more flash memory cells, or may be any secondary or tertiary storage device, such as magnetic media, optical media, tape, or soft or hard disk.

Further, computing platform 212 also includes processor 216, which may be an application-specific integrated circuit (“ASIC”), or other chipset, processor, logic circuit, or other data processing device. Processor 16 or other processor such as ASIC may execute an application programming interface (“API”) (not shown in FIG. 5) that interfaces with any resident programs, such as work scheduling, allocation and tracking module 218 and routines, sub-modules associated therewith or the like stored in the memory 214 of the apparatus 210.

Processor 216 includes various processing subsystems (not shown in FIG. 5) embodied in hardware, firmware, software, and combinations thereof, that enable the functionality of apparatus 210 and the operability of the apparatus on a network. For example, processing subsystems allow for initiating and maintaining communications and exchanging data with other networked devices. For the disclosed aspects, processing subsystems of processor 216 may include any subsystem used in conjunction with work scheduling, allocation and tracking module 218 and related algorithms, sub-algorithms, sub-modules thereof.

Computer platform 212 may additionally include communications module (not shown in FIG. 5) embodied in hardware, firmware, software, and combinations thereof, that enables communications among the various components of the apparatus 210, as well as between the other networked devices. Thus, communication module may include the requisite hardware, firmware, software and/or combinations thereof for establishing and maintaining a network communication connection.

As previously discussed in relation to FIG. 4, the memory 214 of apparatus 210 stores work scheduling, allocation and tracking module 218. The module 218 includes work scheduling sub-module 20 that is configured to define a work process 224. In specific embodiments of the invention, the work process is defined according to a categorization, such that a user may drill-down from selection menus or the like, including a plurality of a line-of-business, a sub line-of-business, a business function, a work process, a work unit or the like. In this regard, the categorization allows for global deployment of the work scheduling, allocation and tracking module 18 across world-wide locations of a global business entity.

The work scheduling sub-module 220 is configured to receive first user-inputs 222 that define the work process by identifying work queues 226. The work queues 226 may be predefined/pre-existing work queues 226A having an associated predefined/predetermined work templates 228A comprised of data elements/data fields 250. Alternatively, the work queues 226 may be newly added work queues 226B having an associated newly created work template 228B comprised of data elements/data fields 250 selected or created by the user.

In specific embodiments of the apparatus, the first user-inputs 222 received by the work scheduling sub-module 220 that define the work process 224 include user-inputs that define work shifts 252 for the work process (i.e., time periods for conducting the work process). In additional embodiments of the apparatus, the first user-inputs 222 received by the work scheduling sub-module 220 that define the work process 224 include user-inputs that define work days 254 for the work process (i.e., the calendar days that the work queues 226 are configured to be accessible by the associates).

In other specific embodiments of the apparatus, the first user-inputs 222 received by the work scheduling sub-module 220 that define the work process 224 include user-inputs that define performance metrics 256 for the work process. The performance metrics may include, but are not limited to, a target, an upper control limit (UCL), a lower control limit (LCL) and the like. In additional embodiments of the apparatus, the first user-inputs 222 received by the work scheduling sub-module 220 that define the work process 224 include user-inputs that define phase 258 for the work process. Phase 258 includes status and/or performance parameters for specific life cycle time periods (0-30 days, On-the-Job Training (OJT), live or the like) over which the work process is to be performed.

Moreover, in still further specific embodiments of the apparatus, the first user-inputs 222 received by the work scheduling sub-module 220 that define the work process 224 include user-inputs that define non-productive activities 60 and/or certification alerts 62. Non-productive activities 260 include, but are not limited to, work breaks, training, briefings/meetings, management information system activity and the like. Certification alerts 262 include inputs for certification cycle, alert recipients, alert timing and the like.

As discussed in relation to FIG. 4, the work scheduling sub-module 220 is configured to receive second user-inputs 232 that define an associate rule set 234 that determines the plurality of associates 236 who are assigned to the work process (i.e., granted access to one or more of the work queues). The associate rule set 234 defines the criteria for the associates qualified to process transactions in the work process. In specific embodiments the associate rule set 34 may include, but is not limited to, criticality of work type 264, certification requirements 266 and the like.

In specific embodiments of the apparatus, the work scheduling sub-module 220 is further configured to receive third user-inputs 264 that prepare the defined work shifts 252 by rostering/scheduling assigned associates 236 to work during the defined work shifts 252 on the defined work days 254.

Additionally, as discussed previously in relation to FIG. 4, work scheduling, allocation and tracking module 218 additionally includes work allocation sub-module 238 that is configured to allocate the work process assignments to the plurality of associates 236. In this regard, work allocation sub-module 238 is configured to automatically, in response to (i) uploading 242 the work templates 228 associated with the work queues 226 and (ii) determining the associates 236, distribute/allocate 240 work process assignments to the determined/assigned associates 236.

In addition, work scheduling, allocation and tracking module 218 additionally includes work tracking sub-module 244 that is configured to automatically (i) track associate work process performance based, at least, on the associate's productivity 246 (i.e., time to perform work transactions and the like), and (ii) communicate completed work transactions to a quality assurance entity for subsequent quality assurance sampling purposes 248 (i.e., choosing samples of completed work transactions for work calibration).

Referring to FIG. 6, a flow diagram is presented of a method 300 for scheduling, allocating and tracking work assignments, in accordance with embodiments of the present invention. At Event 302, first user-input are received that define a work process by identifying one or more work queues and uploading one or more work queues that include work assignments/transactions, each work queue associated with a corresponding work template. The work queues may be predetermined work queues, such that user selects a work queue from a listing of such, or the like. Alternatively, work queues may be newly added work queues, which also require creation of a corresponding new work template. Additionally, the first user-inputs may provide for defining (i) work shifts for performing the work process, (ii) work days for performing the work process, (iii) performance metrics for the work process, (iv) phase requirements for the work process, (v) non-productive activities associated with the work process, (vi) certification requirements/alerts and the like.

At Event 304, second user-inputs are received that define an associate rule set that is used to determine a plurality of associates (i.e., individuals who process the work/carry out the work transactions) who are subsequently assigned to the work process by granting the assigned associates access to the work queues. The associate rule set includes criteria for selecting associates, such as work type criticality, certification requirements and the like.

At Event 306, in response to uploading the work templates and determining the associates, work process assignment are automatically distributed to the assigned associates. At Event 108, the performance of the work process by the associates is automatically tracked based on productivity (e.g., length of time to complete a work assignment/transaction, time spent conducting work assignments/transactions compared to non-productive time). At Event 310, completed work assignments/transactions are automatically communicated to a quality assurance entity for subsequent quality assurance sampling (e.g., a predetermined number or percentage of work assignments/transactions are subjected to calibration processing.

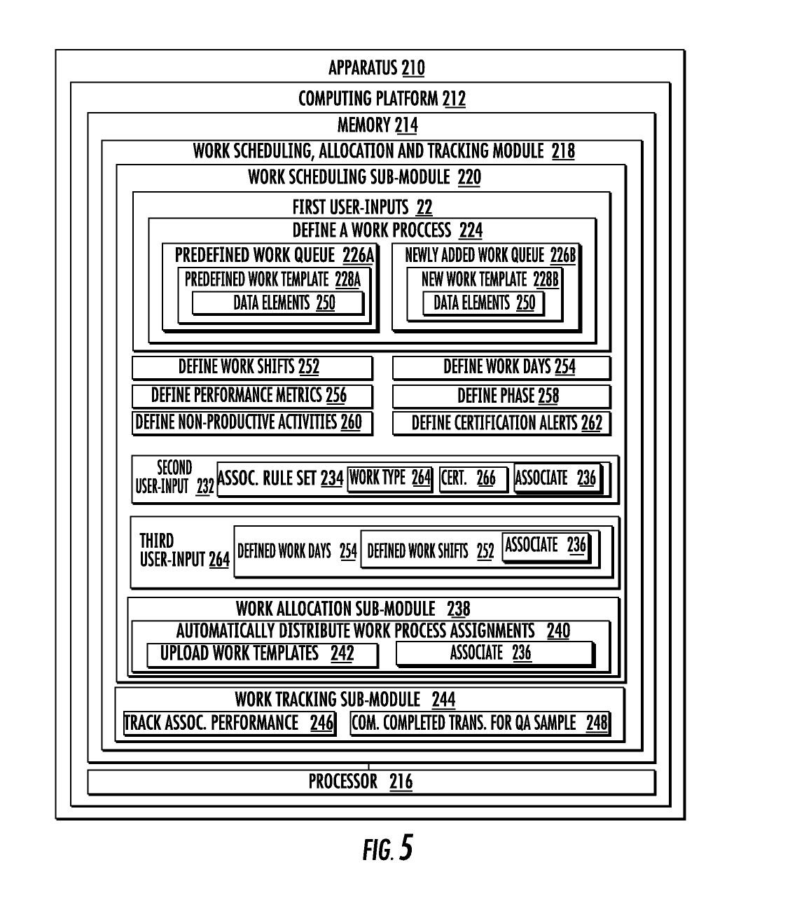

Referring to FIGS. 7-29, exemplary user-interfaces are shown that are implemented by the work process scheduling, allocation and tracking module and/or the work process quality assurance module, in accordance with embodiments of the present invention. Referring to FIG. 7, a user-interface 400 is shown for defining/selecting a work process, in accordance with an embodiment of the present invention. The user-interface 400 is configured to allow a user to choose entries in the drop-down menus; line-of-business (LOB) 402, sub-LOB, 404, business function 406, process 408 and work unit 410, and once entries have been selected and the “Go” key 412 is activated, a work process 414 is displayed. It should be noted that the entries in the drop-down menus will vary in real-time based on previous user selections of an entry in another drop-down menu. In addition, entries in the drop-down menu may be dependent upon the user's access level, such that, only entries and paths corresponding to the user's access level will be visible in the drop-down menus.

The work process 414 display includes various details related to the selected work process, including process ID 416, process name 418, process maker/creator 420, process creation date 422, process checker 424, process checker date 426, activation status 428, approval status 430 and checker comments 432. In addition, the work process 414 display includes “process setup” key 434 that, when activated by the user, allows for changes to the process, including queue setup, shift setup, sampling values, calibration, audit the auditor, associate improvement plan, certifications and metrics setup. A user may activate “save” key 436 to save the work process and activate “cancel” key to remove the work process from the display.

Referring to FIG. 8, a user-interface 500 is shown that includes the various queues associated with a selected work process, in accordance with embodiments of the present invention. User-interface 500 may be presented to specified users of a certain access level, in response to a user activating the “process setup” key 434 shown in FIG. 7.

User-interface 500 includes tabs for queue setup 502, shift setup 504 and non-productive activity 506. A user may select a tab to view and/or edit information within the chosen tab category. In the illustrated user-interface 500 the queue setup 502 tab has been selected or initially presented to the user. The queue information displayed includes queue name 508, approval status 510, maker/creator of queue 512, date queue was created 514, queue checker 516, date queue was checked 518, and checker comments 518. Additionally, the queue information includes activatable “edit” keys, which, when activated by the user allow the user to edit the queue information (e.g., change queue name or the like). Additionally, check-box 522 are provided, which when activated/checked by a user in conjunction with activating the “delete” key, allows for the user to delete queues from the work process. In addition, the user-interface 500 provides for a “add new” key 526, which, when activated by a user, allows the user to add a new queue. A pop-up window/user-interface (not shown) may be displayed which always the user to name the new queue and choose a queue type (e.g., normal (i.e., implements end-to-end processing provided by the module) or work upload-only (i.e., limited to defining a template and facilitating QA entity to conduct audit)).

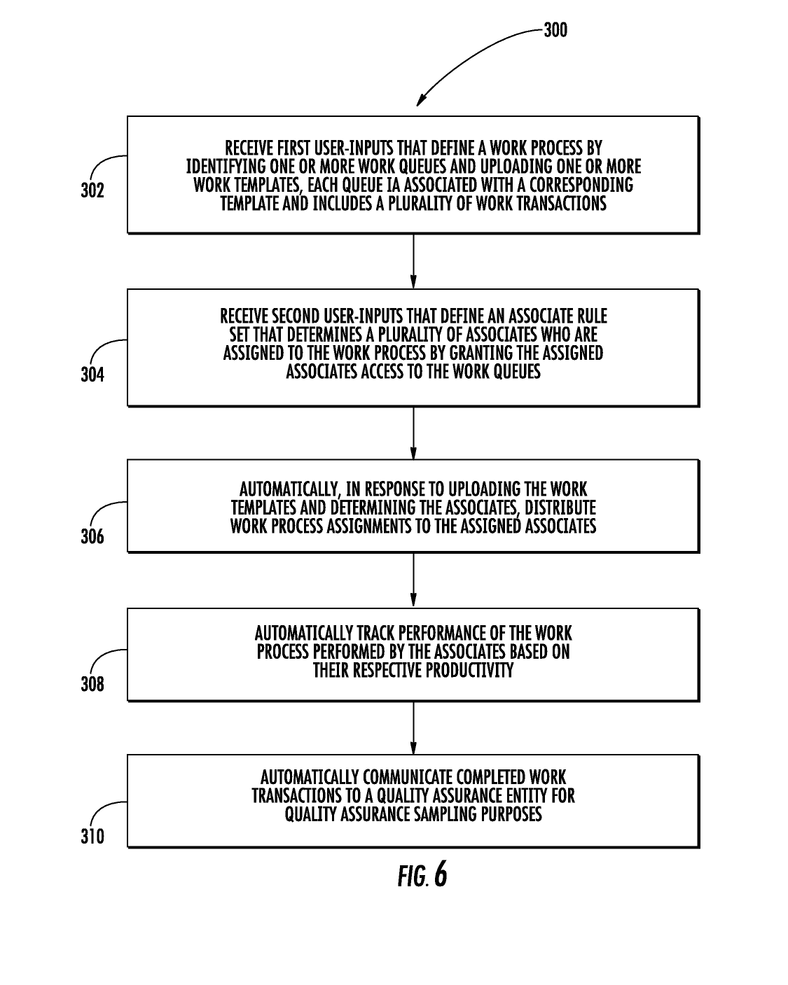

Referring to FIG. 9, a user-interface 600 is shown that allows users to add a new work shift to a work process, in accordance with embodiments of the present invention. User-interface 600 includes drop-down menus for shift name 602, country where shift will occur 604, and location/cite within country where shift will occur 606. In addition, user-interface 600 provides for a login tolerance window 608 that is configured to allow the user to define the number of minutes (i.e., grace period) beyond the start time of the shift in which an associate/worker can login without be subjected to a “late arriving” status. User-interface 600 additionally includes “save & add new” key 610, “save” key 612 and “reset” key 614 for adding the new shift, saving the new shift or resetting the information displayed in user-interface 600; respectively.

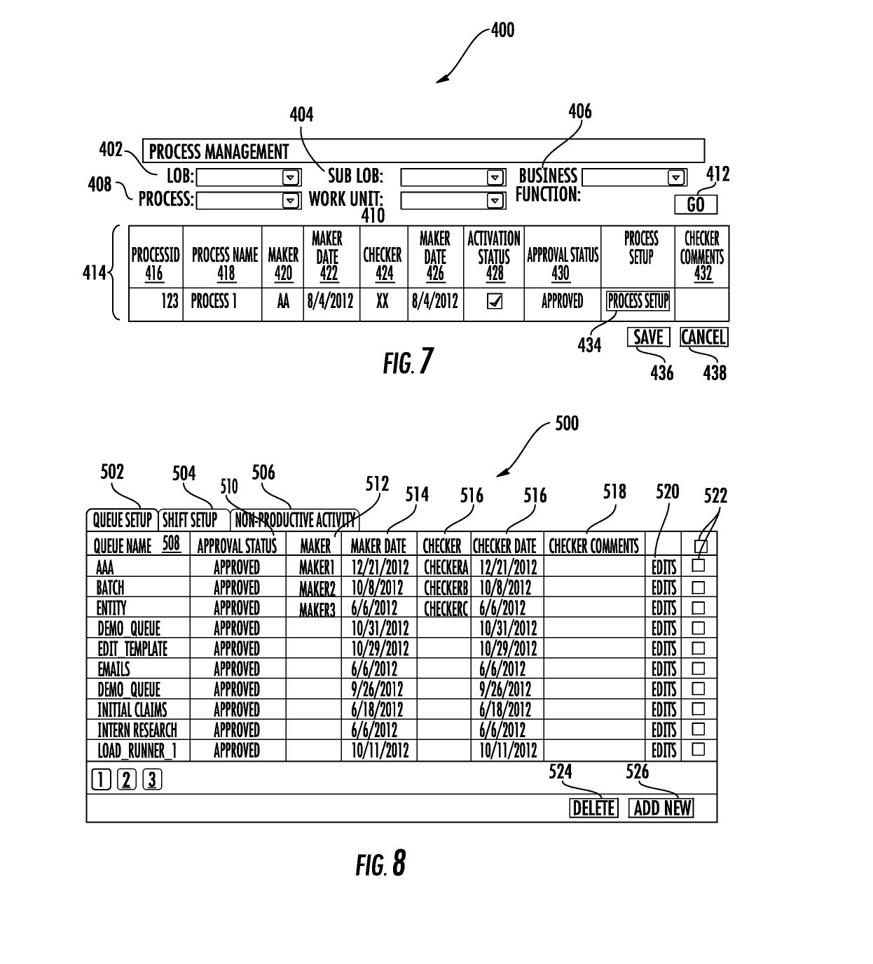

Referring to FIG. 10 a user-interface 700 is displayed that allows users to setup the performance metrics for a work process, in accordance with embodiments of the present invention. User-interface 700 includes tabs for metrics setup 702, phased setup 704, work days 706 and certification 706. A user may select a tab to view and/or edit information within the chosen tab category. In the illustrated user-interface 700 the metrics setup 702 tab has been selected or initially presented to the user.

The performance metrics information 710 included in user-interface 700 includes performance metric name 712, target value 714, lower control limit (LCL) 716, upper control limit 718, performance metric type 720, approval status 722 and view 724. The user can add values for target, LCL and UCL and select a metric type (e.g., Critical-to-Quality (CTQ), Critical-to-Process (CTP), no work, not received) from the drop-down menu for a chosen performance metric. Additionally, the performance metrics information 710 included in user-interface 700 includes ageing/turnaround-time (TAT) percentage color-coding entry fields for “green upto” 726, “yellow upto” 728, “amber upto” 730 and “red” 732, which serve to alert the associate of the longevity of the work process. In addition, the performance metrics information include a turnaround-time (TAT) 734 performance metric, which allows the user to enter the desired turnaround time (in hours) for the work process. The view 724 fields provide an activatable link that user may activate to view the active settings for the corresponding performance metric and, if applicable, the “pending approval” settings.

User-interface 700 additionally proves for a check duplicates option 736, which, when checked as “yes” by the user, provides for checks to be made to identify duplicate records of the data for a specified period of time. Moreover, user-interface 700 includes entry fields for steady state process date 738, CTQ baseline 740 and sigma baseline 742.

Once a user has inputted the required changes to the performance metric, the user will select the metric via the checkbox 744 and activate “save” key 746 to save the performance metric changes. The “reset” key 748 can be used to remove all of the settings/entries for selected performance metrics.

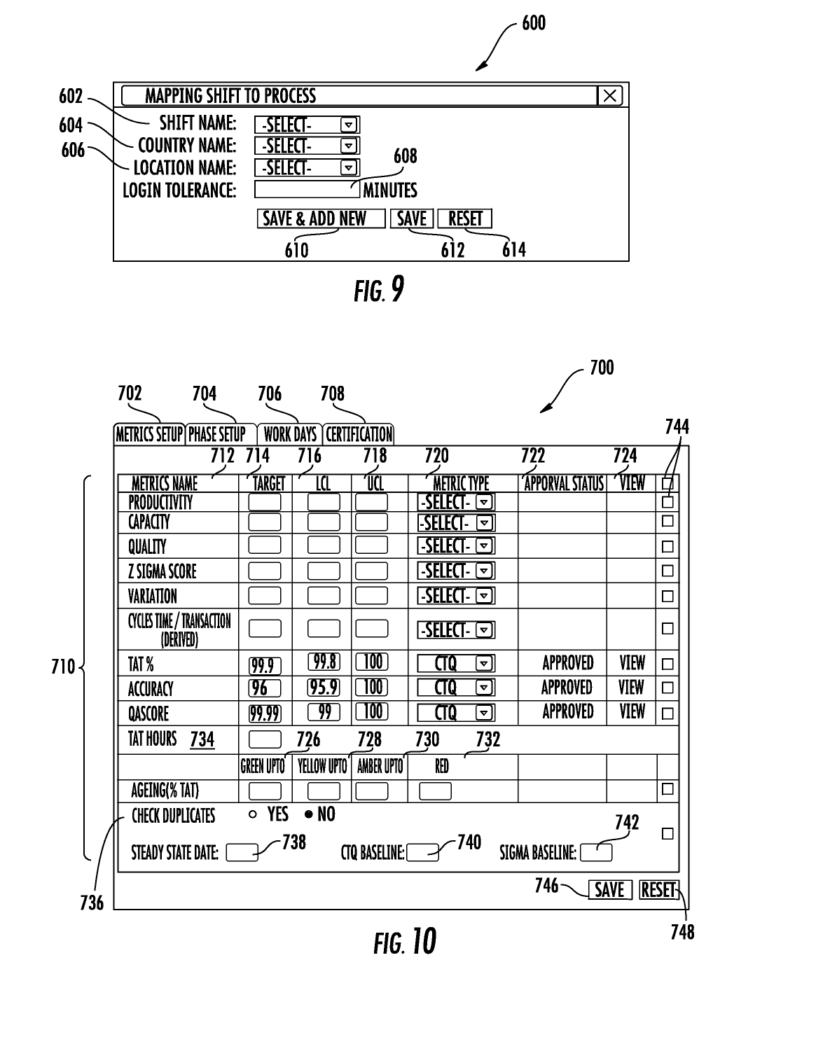

Referring to FIGS. 11-12, user-interfaces 800, 900 are presented for conducting phase set-up of a work process, in accordance with embodiments of the presented invention. A “phase” as used herein, is work state of an associate/worker as it applies to the work process. For example, phases may include, but are not limited to, different levels of training, on-the-job-training (OJT), live and the like. User-interface 800 of FIG. 11 provides a drop-down menu of phase names 802, once the user has selected a phase name from the drop-down menu and activated the “go” key 804, the user is presented with the phase metric setup user-interface 900 shown in FIG. 12.

User-interface 900 allows the user to set or change the various parameters for a chosen phase. In the illustrated example of FIG. 12, the user has selected thee phase “on-the-job-training (OJT) 1”. As such user-interface 900 includes fields for phase metric name 902, LOB 904, stretch 906, approval status 908, creator/maker 910, date phase metric was created 912, checker 914, checker date 916 and checker comments 918. User-interface 900 also allows the user to the time period for the phase and, as such includes entry fields for “allowed days 924 and “grace period” 926 (i.e., the number of days past the allowed days during which the phase may continue). The view 928 fields provide an activatable link that user may activate to view the active settings for the corresponding phase metric and, if applicable, the “pending approval” settings.

Once a user has inputted the required changes to the phase metric setup and/or phase duration, the user will select the phase metric and/or phase duration via the checkbox 930 and activate “save” key 932 to save the phase metric and/or phase duration changes.

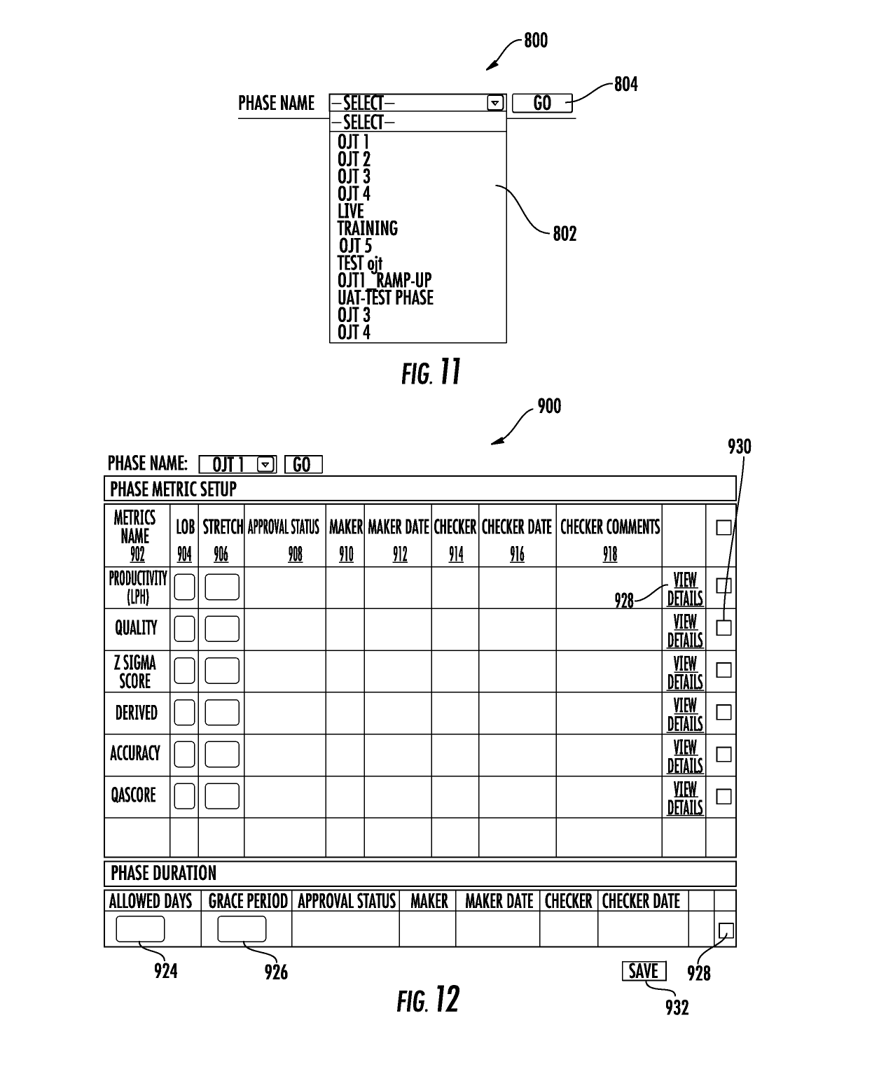

FIG. 13 present a user-interface 1000 configured for a user to select the work days during which associates may work on the work process, in accordance with embodiments of the present invention. User-interface 1000 provides a drop-down menus for month 1002 and year 1004, which upon selection by the user and activation of the “view” key 1006, present a scrollable display 1008 of the days of the selected month. A user may check the check-box 1010 associated with the day in the displayed month to designate the day as a work day (or uncheck a previously checked check-box to designate a day as a non-work day. Once the user has completed the work day selection process, the user activates the “save” key 1012 to save the work day settings. As a result, associates/workers will only be able to access work queues on days that have been designated work days. “Reset” key 1014 can be activated to clear all previous changes made to the checkboxes 1010.

Referring to FIG. 14, a user-interface 1100 is presented that allows users to define a process certification cycle time and/or Process Knowledge Test (PKT) cycle time, in accordance with embodiments of the present invention. Associates may be required to complete a queue specific certification before beginning work on a queue and be re-certified after a specified number of days (i.e., certification cycle time). User-interface 1100 includes entry fields for process certification cycle 1102 and PKT cycle 1104 and corresponding fields for the maker/creator 1106, date of creation 1008, checker 1110 and checker date 1112. The “save” key 1114 allows the user to save changes to the process certification cycle and/or PKT cycle and the “view” key 1116 allows the user to pull-up (e.g., via pop-up window) the current process certification cycle and PKT cycle.

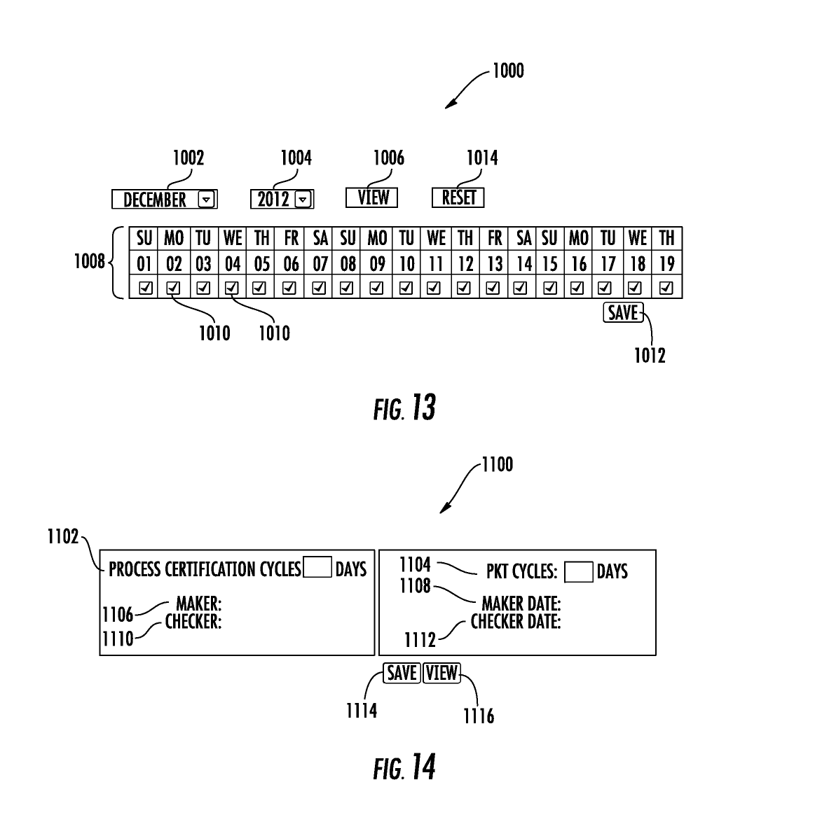

FIGS. 15-18 provide user-interfaces for work template management, in accordance with embodiments of the present invention. Each work template corresponds to a work queue and includes data elements associated with the work queue. As such, work templates provide the formats in which work/data will be uploaded and processed. In the illustrated user-interface 1200 of FIG. 15 a user may locate a template via drill down methodology using drop down menus corresponding to LOB 1202, Sub-LOB 1204, business function 1206, process 1208, work unit 1210 and queue 1212. The drop-down menus of user-interface 1200 operate in a similar fashion as the drop-down menus shown and described for user-interface 400 shown in FIG. 7. In the illustrated example of FIG. 15, the chosen queue has no template currently defined for it, and therefore, the user is presented with indication window 1214 and the “add new template” key 1216. FIG. 16 provides an intermediary user-interface that is presented to the user in response to activating the “add new template” key of user-interface 1200. User-interface 1300 is configured to allow the user to add data elements to the template by activating “add new element” key 1302. The user may activate “close” key 1304 to exit the new template addition process.

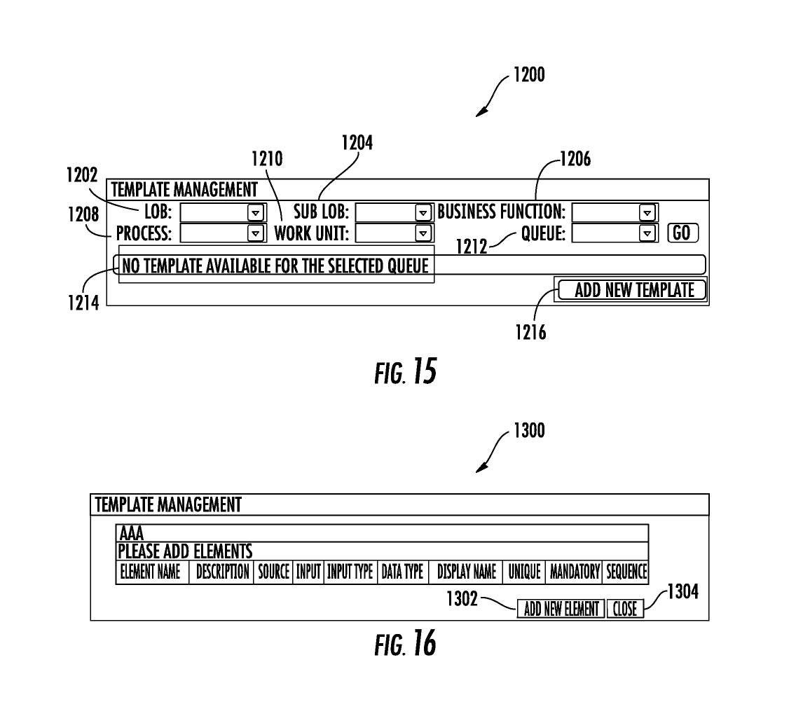

Referring to FIG. 17 a user-interface 1400 is shown that displays the fixed data elements required of all new work templates, in accordance with embodiments of the present invention. The fixed data element user-interface 1400 includes element name 1402, display name 1404, input type 1406, data type 1408, sequence 1410 and mandatory 1412 The fixed data element names 1402 include (a) received date 1414, (b) work type 1416, (c) associate ID (e.g., NBKID) 1418, and (d) work priority 1420. The received date 1414 is the date the data set is received and defines the starting date for turnaround time. The work type 1416 defines the complexity level of the transaction. In specific embodiments, work types may be A, B, C or D, where A is the most complex and D is the least complex. Associates are assigned a corresponding work type and can only work on transactions at or below the work type that they are currently assigned to. The associate ID 1418, which is not mandatory for the user to complete, identifies the associate that is to be assigned to the work assignment/transaction. Additionally, the work priority 1420, which is also not mandatory for the user to complete, specifies the priority attached to a work assignment/transaction. The “view items” link 1422 is activatable to display the items associated with the selected element name 1402.

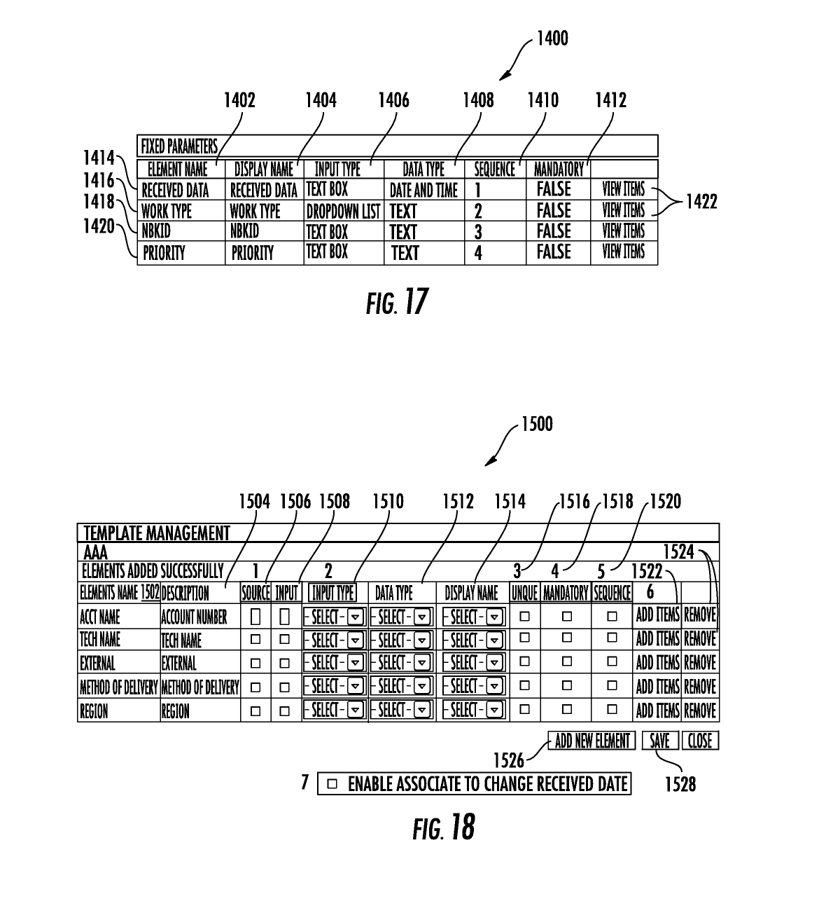

FIG. 18 presents a user-interface 1500 for additional data elements added to the template, in accordance with embodiments of the present invention. Once the user selects the “add new element” key 1302 shown in the user-interface 1300 of FIG. 16, the user is presented with a master list of all available data elements and selects the data elements required for the corresponding work queue. As a result of the selection of data elements, the user-interface 1500 shown in FIG. 18 is displayed. The user-interface 1500 lists the data elements added and includes data element name 1502, description 1504, source check-box 1506, input check-box 1508, input type drop-down menu 1510, data type drop-down menu 1512, display name entry field 1514, unique check-box 1516, mandatory check-box 1518 and sequence check-box 1520. Source and input check boxes 1506 and 1508 allow the user to indicate if that data element should take its data while the work is uploaded (i.e., source) or when the transactions are processed downstream (i.e., input). Input type 1510 is applicable only if input check box 1508 is checked and allows the user to choose the input type (e.g., text box, drop-down menu, check box/radio button or the like). Data type 1512 is applicable only when the input type selected is “text box” and allows the user to choose the data type to be received in the text box. The display name entry field 1514 may be auto-populated with the data element name but is configured to allow the user to edit the data element name with a display name of the user's choosing. The unique check-box is applicable only if the user selects the source check box 1510 is checked and allows the user to designate that the data for this element should be unique. The mandatory check-box 1518 allows the user to designate the data element as being mandatory to fill in the data associated with data element. The sequence check-box 1520 allows the user to designate the data element as requiring sequencing or ordering (i.e., displayed in a specified sequence in the work template and/or a specified input sequence required by the associate on the work processing user-interface).

Additionally, user-interface 1500 includes “add items” links 1522 which, when activated by a user, allow the user to mention the items/options under drop-down menu, check-box/radio button. List box or the like. Moreover, “remove” links 1524 allow the user to delete the data element from the list of added data elements. “Add new element” key 1526, when activated by the user, allows the user to add additional new elements and the “save” key 1528, when activated by the user, allows the user to save the listed new data elements. In addition, the “close” key 1530 will return the user to the template management screen (user-interface 1200 of FIG. 15). Check-box 1532, when checked by the user, allows the user to configure the “received date” fields on the work processing user-interface to be editable by the associate.

FIGS. 19-21 provide user-interfaces for associate access management, in accordance with embodiments of the present invention. Referring to FIG. 19, the list of associates provided in user-interface 1600 may be generated by drill-down methodology using the LOB drop-down menu 1618, sub-LOB drop-down menu 1620, business function drop-down menu 1622, process drop-down menu 1624 and work unit drop-down menu 1626 and subsequently activating “go” key 1627. User-interface 1600 of FIG. 19 allows users to add listed associates to a work process by checking the check-box 1602; all associates listed may be added by checking the top—most check-box 1602A or individual associated may be added by checking corresponding individual associate check-boxes 1602B, and subsequently activating the “save” key 1628. The associate list includes associate name 1604, associate ID number (NBKID) 1606, reporting manager name 1608, role 1610, access 1612, status 1614 and effective date 1616. The role 1610 drop-down menu allows the user to choose a specific role for the associate. Additionally, as shown in FIG. 19, the access 1612 drop-down menu allows the user to choose whether the associate is required to have access or is otherwise blocked from access.

Additionally, user-interface 1600 includes filters and search capability in the form of access drop-down menu 1630, status drop-down menu 1632, “my directs” and “all” radio check-boxes 1634 and 1636 and search criteria drop-down menu 1638 and input fields 1640.

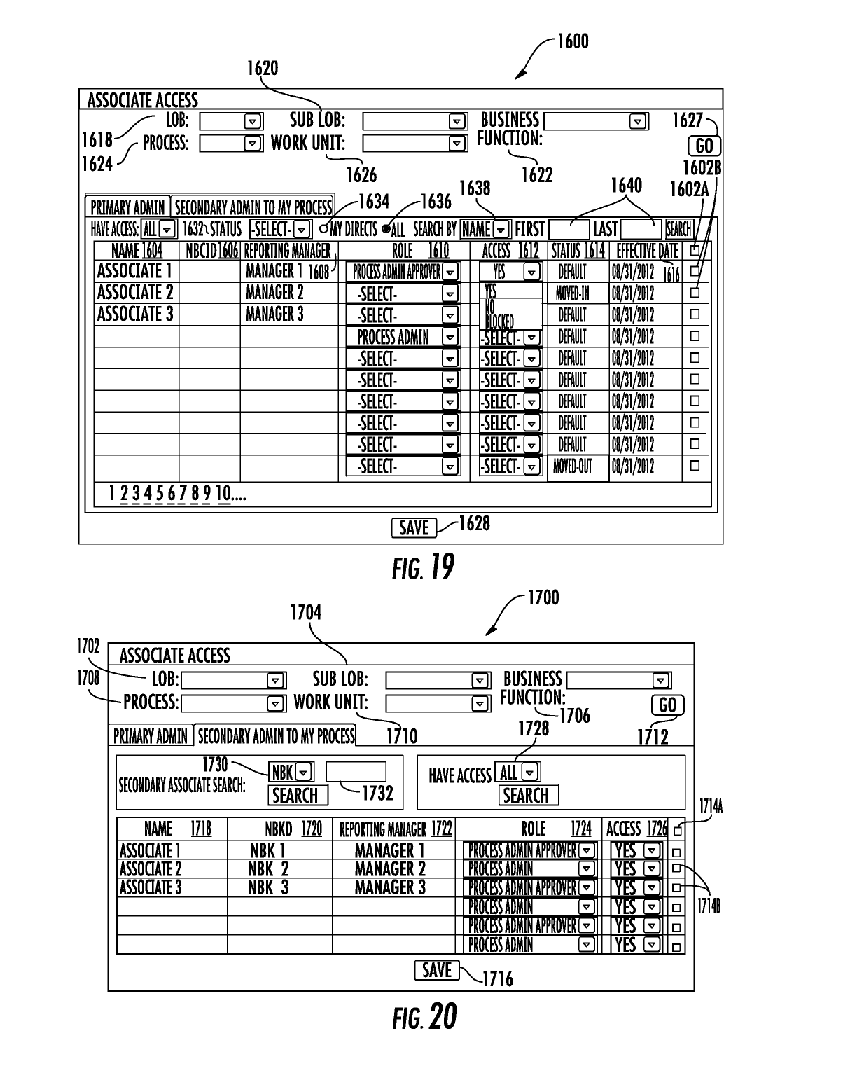

FIG. 20 presents a user-interface 1700 configured to allow users to add secondary associates to a work process, in accordance with embodiments of the invention. Secondary associates are defined herein as associates not primarily accessible to the user that are additionally needed for the work process at hand. The list of associates provided in user-interface 1700 may be generated by drill-down methodology using the LOB drop-down menu 1702, sub-LOB drop-down menu 1704, business function drop-down menu 1706, process drop-down menu 1708 and work unit drop-down menu 1710 and subsequently activating “go” key 1712. Secondary associates may be added to the work process by checking the check-boxes 1714; all associates listed may be added by checking the top—most check-box 1714A or individual associated may be added by checking corresponding individual associate check-boxes 1714B, and subsequently activating the “save” key 1716. The secondary associate list includes associate name 1718, associate ID number (NBKID) 1720, reporting manager name 1722, role 1724, and access 1726. The role 1724 drop-down menu allows the user to choose a specific role for the secondary associate. Additionally, as shown in FIG. 20, the access 1726 drop-down menu allows the user to choose whether the secondary associate is required to have access or is otherwise blocked from access.

Additionally, user-interface 1700 includes filters and search capability in the form of access drop-down menu 1728, and search criteria drop-down menu 1730 and input fields 1732.

Referring to FIG. 21, shown is another user-interface 1800 configured for adding associates to a work process, in accordance with embodiments of the present invention. In specific embodiments, users may be presented user-interface 1800, as opposed to the user-interfaces 1600 and 1700 shown in FIGS. 19 and 20, based on the roles/status of the users. The list of associates provided in user-interface 1800 may be generated by drill-down methodology using the LOB drop-down menu 1802, sub-LOB drop-down menu 1804, business function drop-down menu 1806, process drop-down menu 1808 and work unit drop-down menu 1810 and subsequently activating “go” key 1812. Additionally, user-interface 1800 includes filters and search capability in the form of access drop-down menu 1814, status drop-down menu 1816, “my directs” and “all” radio check-boxes 1818 and 1820, location drop-down menu 1822 and search criteria drop-down menu 1824 and input fields 1826.

The associate list shown in user-interface 1800 includes associate name 1828, associate ID number (NBKID) 1830, reporting manager name 1832, certification date 1834, certification expiration date 1836, work type drop-down menu 1838, role drop-down menu 1840, access drop down menu 1842, phase drop-down menu 1844, phase comment drop-down menu 1846, status 1848, effective date 1850 and location 1852. The work type and role drop-down menus 1838 and 1840 allow the user to choose a specific work type (e.g., A-D signifying skill level of the associate) and role for the associate. Additionally, as shown in FIG. 21, the access drop-down menu 1842 and phase drop-down menu 1844 allow the user to choose whether the associate is required to have access or is otherwise blocked from access and choose the current state/phase of the user (e.g., 0-30 days, 30-60 days, OJT, live or the like). Users add listed associates to a work process by checking the check-boxes 1854; all associates listed may be added by checking the top—most check-box 1854A or individual associated may be added by checking corresponding individual associate check-boxes 1854B, and subsequently activating the “save” key 1856.

Additionally, a user may navigate to other user-interfaces for adding secondary associates to the work process and loaning associates to other work processes by activating “secondary admin to my process” tab 1858 or “secondary admin to other process” tab 1860.

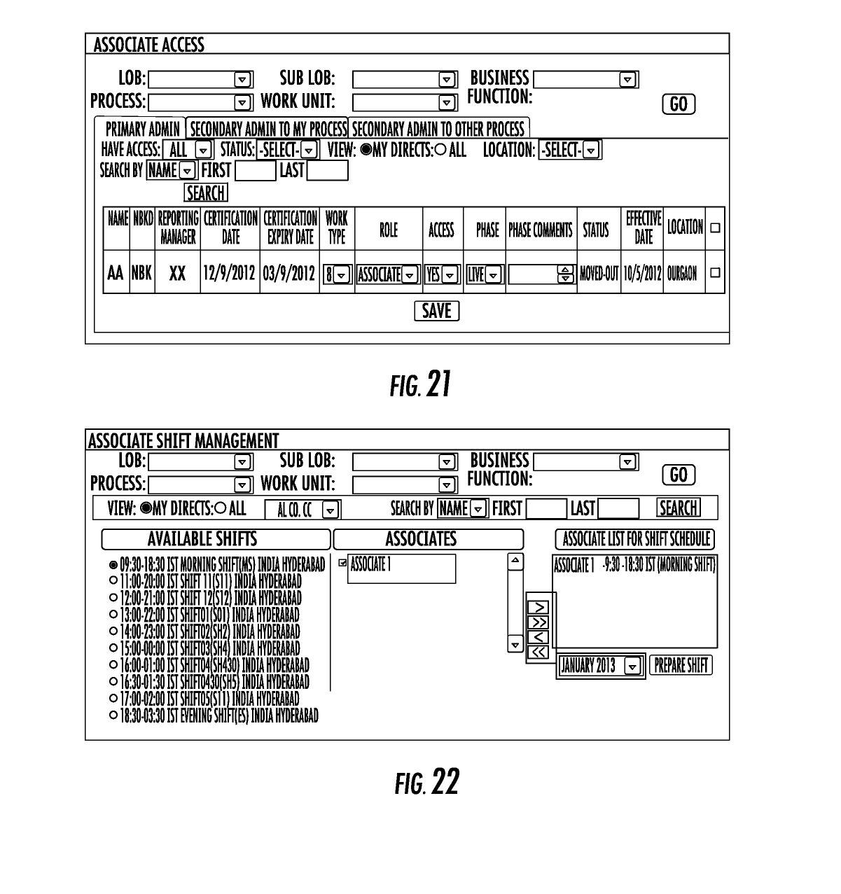

Referring to FIG. 22, a user-interface 1900 is depicted for managing associates shifts for a work process, in accordance with embodiments of the invention. The work process may be located by drill-down methodology using the LOB drop-down menu 1902, sub-LOB drop-down menu 1904, business function drop-down menu 1906, process drop-down menu 1908 and work unit drop-down menu 1910 and subsequently activating “go” key 1912. Additionally, user-interface 1900 includes associate filters and search capability in the form of “my directs” and “all” radio/check boxes 1914 and 1916 and search criteria drop-down menu 1918 and input fields 1920. User-interface 1900 lists available work shifts 1922 by time and location and lists associates 1924 that have previously been added to the work process and meet the user-inputted filter and/or search criteria. Additionally, user-interface 1900 includes a drop-down menu 1926 for selecting the month/year for which the work shifts are being prepared and the associate list for the shift schedule 1928 which is built by checking the radio/check-box associated with a work shift and a listed associate and activating an arrow key 1930 to move one or more associates to the associate list for the shift schedule box 1932. The user activates the “prepare shift” key 1934 to complete the shift scheduling process.

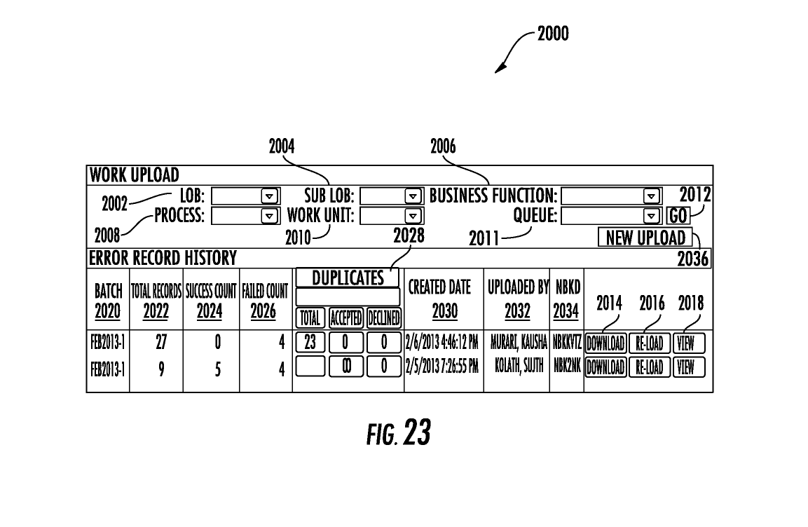

FIG. 23 depicts a user-interface 2000 for uploading a work queue/template for a specified work process, in accordance with embodiments of the present invention. The work process may be located by drill-down methodology using the LOB drop-down menu 2002, sub-LOB drop-down menu 2004, business function drop-down menu 2006, process drop-down menu 2008, work unit drop-down menu 2010 and queue drop-down menu 2011, and subsequently activating “go” key 2012. In the illustrated example of FIG. 23 the user-interface 2000 depicts the error records of all of the previous uploads for the work process. The user-interface 2000 is configured to allow the user to activate “download” link 2014 and take corrective action on the errors and, subsequently activate “re-upload” link 2016 to re-upload the same file/queue to the same batch. Additionally, the user-interface 2000 is configured to allow the user to activate “view” link 2018 to view the upload batch history of the queue. The error record history includes listings for batch number 2020, total number of records 2022, success count 2024, failed records 2026, duplicates 2028 broken down by total, accepted and declined, creation date 2030 name of user that performed upload 2032 and identification number (NBKID) of user that performed upload 2034. Additionally, a user may activate “new upload” key 2036 to initiate a new work upload.

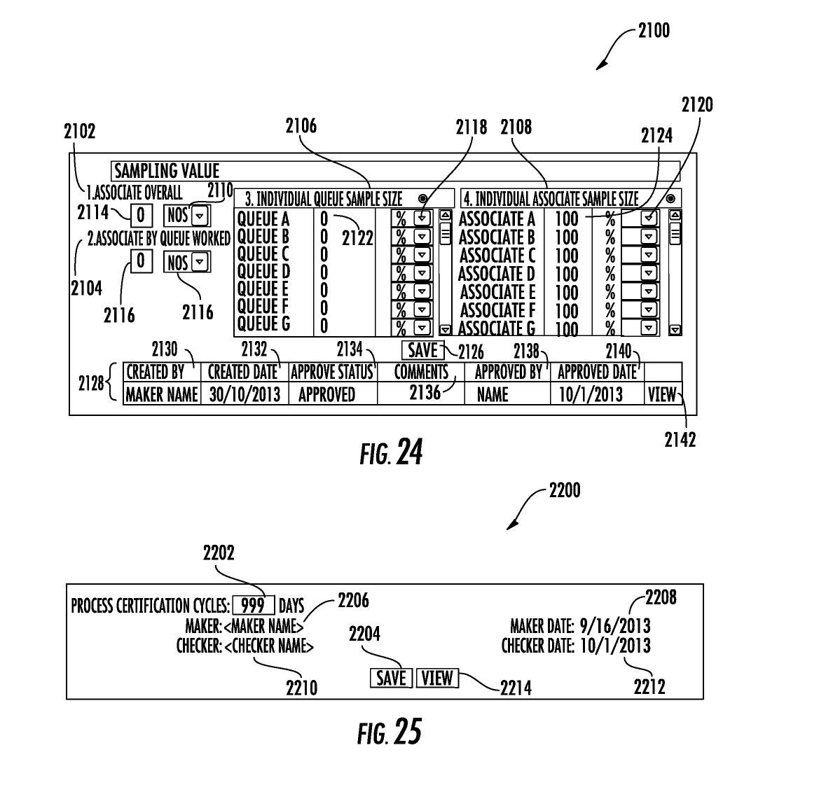

FIGS. 24-29 depict examples of user-interfaces that may be implemented by the work process quality assurance module herein described, in accordance with embodiments of the present invention. Specifically, FIG. 24 depicts an example of a user-interface 2100 configured to allow users to define sampling sizes for work processes. In the illustrated example, the user-interface 2100 allows the user to define sampling sizes for different sampling constraints; specifically, (i) associate overall 2102, (ii) associated by queue worked 2104, (iii) individual queue sample size 2106, and (iv) individual associate sample size 2108. For associate overall 2102 and associate by queue worked 2104, a user will implement drop-down menus 2110 and 2112 to choose between a finite number option or a percentage option and enter a corresponding chosen finite number or percentage in the entry field 2114 and 2116. Similarly, for individual queue sample size 2106 and individual associate sample size 2108, a user will implement drop-down menus 2118 and 2120 to choose between a finite number option or a percentage option for each queue and/or associate and enter a corresponding finite number or percentage in the corresponding entry field 2122 and 2124. Once all of the sampling settings have been entered, the user activates “save” key 2126 to save the sampling settings.

In addition, user-interface 2100 provides for an audit trail table 2128 that includes entries for the previous changes to the settings including name of creator/setting changer 2130, date settings created/changed 2132, approval status 2134, comments 2136, name of approver 2138 , and date of approval 2140. The audit trail table 2128 additional includes “view” link 2142, which, upon activation be the user, displays the input values associated with the corresponding setting creation or setting change.

Referring to FIG. 25 a user-interface 2200 is presented that is configured to allow a user to define calibration cycles, in accordance with embodiments of the present invention. The user-interface 2200 includes certification cycle entry field 2202 that allows a user to enter the number of days that a process certification will remain valid and, subsequently, activate the “save” key 2204 to save the calibration cycle setting. Moreover, the user-interface 2200 provides additional information related to calibration cycle settings including the name of the calibration cycle creator/maker 2206, the date of the calibration setting 2208, the name of the calibration cycle checker 2210 and the date of the check 2212. Additionally, a “view” key 2214 is provided that allows the user checkers to approve or reject the settings.

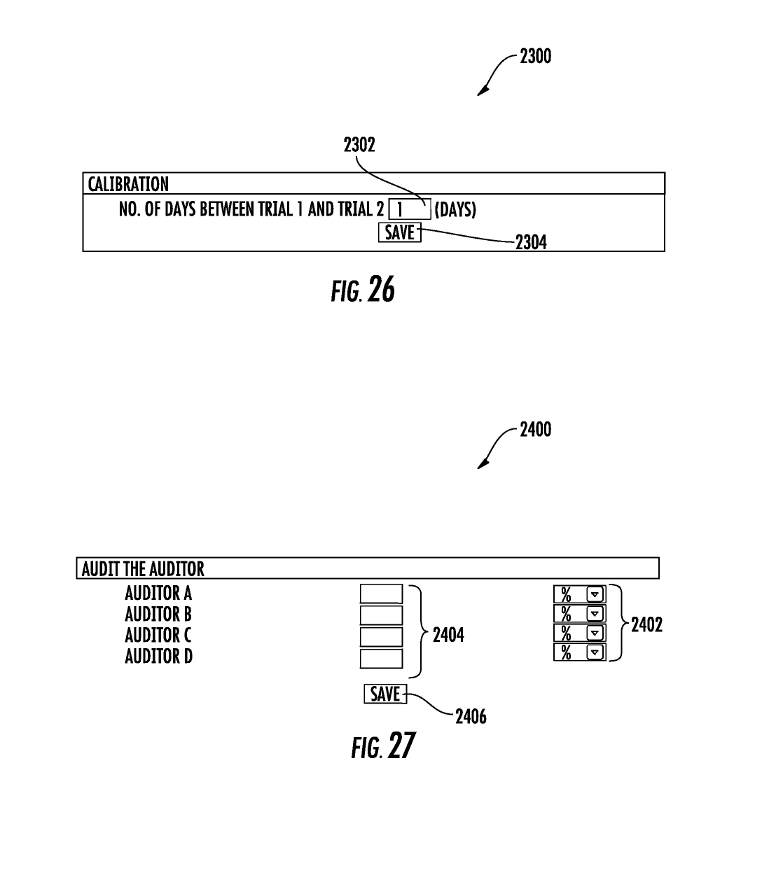

FIG. 26 depicts a user-interface 2300 configured to allow a user to define the number of days between calibration trials, in accordance with embodiments of the present invention. User-interface 2300 in includes data entry field 2302 that is configured to allow the user to enter a numerical value between 0 and 99 to define the number of days between calibration trials and, upon activating “save” key 2304, save the calibration cycle settings.

Referring to FIG. 27 a user-interface 2400 is depicted that allows the user to define the sample sizes for performing quality assurance on the QA process (i.e., auditing the auditor). As such, user-interface 2400 includes drop down menus 2402 for each listed auditor that allows a user to choose between a finite number option or a percentage option and data entry fields 2404 that allow the user to enter a corresponding finite number or percentage. Once the number versus percentage option has been chosen and a corresponding value entered, the user activates “save” key 2406 to save the audit the auditor settings.

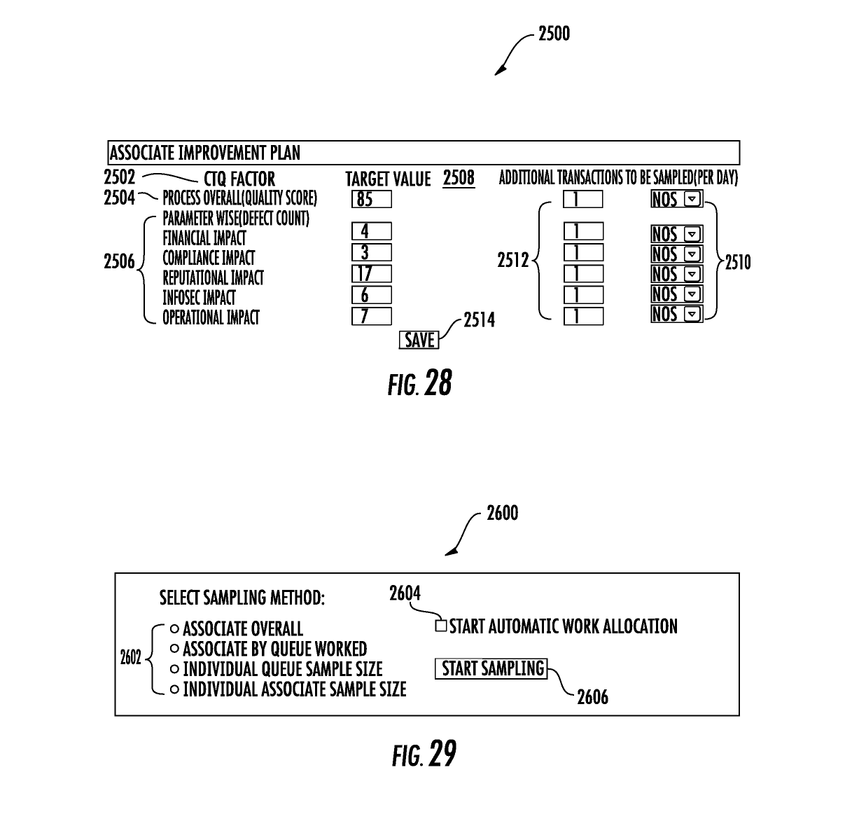

FIG. 28 depicts a user-interface 2500 that allows a user to define an associate improvement plan (AIP) for associates currently requiring improvement due to an insufficient quality score and/or performance metrics, in accordance with embodiments of the present invention. The user-interface 2500 includes a listing of critical-to-quality factors 2502 including an overall quality score 2504 for the associate and individual performance metrics 2506. Additionally, user-interface 2500 provides a user to input target values 2508 for the overall quality score and each individual performance metric. In addition, the user-interface 2500 includes drop-down menus 2510 for a user to choose between a finite number option and a percentage option for quantifying additional assignments/transactions that are to sampled on a daily basis and a corresponding data entry field 2512 for entering a corresponding finite number or percentage. Once the target values and additional transaction samples have been defined, the user activates “save” key 2514 to save the settings.

Referring to FIG. 29 a user-interface 2600 configured for allowing a user to initiate automated sampling of work assignments/transactions, in accordance with embodiments of the present invention. The user-interface 2600 allows the user, through activation of one of the radio buttons/check box-scores 2602 to choose one of the four sampling methods previously discussed in relation to FIG. 24. The sampling methods include (i) associate overall, (ii) associate by queue worked, (iii) individual queue, and (iv) individual associate. Additionally, user-interface 2600 includes a radio button/check box 2604 for initiating automatic work allocation, which, when activated by a user, assigns the sampled data general QA queue (i.e., random allocation of the QA samples). In response to selecting a sampling method and, optionally, selecting the start automatic work allocation option, a user activates the “start sampling” key 2606 to begin sampling. The output of the sampler will be random and will be based on the logic of the chosen sampling method.

Thus, systems, apparatus, methods, and computer program products described above provide for a comprehensive quality assurance platform for automatically assessing the quality of work performance of associates. As such, present embodiments significantly increase repeatability and reproducibility into the overall performance of work assignments. The described quality assurance system/module that can be implemented in conjunction with the work allocation system described herein or the system can operate as a standalone quality assurance system/module. In addition, the quality assurance system provides for automated collection and tracking of quality metrics and automated quality calibrations (i.e., automated and random selection of work assignment/transactions for comparison to standards). Additionally, the quality assurance system provides for validating the quality assurance work by random sampling and quality assurance processing of the auditor's work (i.e., auditing the auditors). Moreover, the quality assurance aspects of the present invention provide for an associate improvement plan, whereby quality assurance metrics may be systematically adjusted and/or sampling sizes increased for associates with quality scores that dictate a need for improvement.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for quality assurance assessment of a work process, the apparatus comprising:
a computing platform having a memory and at least one processor in communication with the memory; and
a work process quality assurance module stored in the memory, executable by the processor and including:
a work transaction quality assurance (QA) sampling sub-module configured to:
receive first user-inputs that define a sample size for each of a plurality of sampling constraints,
receive second user-inputs that select a time and date range for sampling completed work transactions from the work process,
receive third user-inputs that select one or more work queues from the work process to be sampled,
receive a fourth user-input that selects a sampling constraint from amongst the plurality of sampling constraints, and
receive a fifth user-input that is configured to automatically and randomly determine samples for quality assurance assessment in accordance with (i) the selected time and date range, (ii) the selected work queues, (iii) the selected sampling constraint and (iv) the selected sample size associated with the selected sampling constraint.

2. The apparatus of claim 1, wherein the work transaction QA sampling sub-module is further configured to receive first user-inputs that define a sample size for each of the plurality of sampling constraints, wherein the sampling constraints include (i) an overall population of associates assigned to a work process, (ii) each associate for each work queue worked by a corresponding associate, (iii) each individual queue in the work process, and (iv) each individual associate assigned to the work process.

3. The apparatus of claim 1, wherein the work transaction QA sampling sub-module is further configured to receive a sixth user-input that is configured to automatically and randomly allocate the determined samples to a general quality assurance queue.

4. The apparatus of claim 1, wherein the work transaction QA sampling sub-module is further configured to receive first user-inputs that define a sample size for each of a plurality of sampling constraints, wherein each sample size may be one of a percentage or a numerical value.

5. The apparatus of claim 1, wherein the work process quality assurance module further comprises an associate calibration sub-module configured to receive a sixth user-input that defines a number of days between calibration trials.

6. The apparatus of claim 5, wherein the associate calibration sub-module is further configured to, based on the number of days between calibration trials expiring for an associate, automatically, and without knowledge of the associate, allocate a transaction performed by the associate to a general calibration queue in which the transaction is compared to a calibration standard.

7. The apparatus of claim 1, wherein the work process quality assurance module further comprises an auditor quality assurance sub-module that is configured to receive a sixth user-input that defines an auditor-specific sample size of the work process transactions that undergo quality assurance assessment by the auditor.

8. The apparatus of claim 1, wherein the work process quality assurance module further comprises an associate improvement plan sub-module that is configured to receive sixth user-inputs that define, for an associate requiring process improvement, target values for (i) an overall quality score and (ii) individual work process parameters and an additional sample size of work process transactions performed by the associate that are to be quality assurance sampled.

9. The apparatus of claim 1, wherein the work process quality assurance module further comprises a certification sub-module that is configured to receive a sixth user-input that defines a process certification cycle for a specified work process.

10. A computer program product comprising:
a non-transitory computer-readable medium comprising:
a first set of codes for causing a computer to receive first user-inputs that define a sample size for each of a plurality of sampling constraints;
a second set of codes for causing a computer to receive second user-inputs that select a time and date range for sampling completed work transactions from the work process;
a third set of codes for causing a computer to receive third user-inputs that select one or more work queues from the work process to be sampled;
a fourth set of codes for causing a computer to receive a fourth user-input that selects a sampling constraint from amongst the plurality of sampling constraints, and
a fifth set of codes for causing a computer to automatically and randomly determine samples for quality assurance assessment in accordance with (i) the selected time and date range, (ii) the selected work queues, (iii) the selected sampling constraint and (iv) the selected sample size associated with the selected sampling constraint.

11. The computer program product of claim 10, wherein the first set of codes is further configured to cause the computer to receive the first user-inputs that define the sample size for each of the plurality of sampling constraints, wherein the sampling constraints include (i) an overall population of associates assigned to a work process, (ii) each associate for each work queue worked by a corresponding associate, (iii) each individual queue in the work process, and (iv) each individual associate assigned to the work process.

12. The computer program product of claim 10, wherein the computer-readable medium includes a sixth set of codes for causing a computer to automatically and randomly allocate the determined samples to a general quality assurance queue.

13. The computer program product of claim 10, wherein the first set of codes is further configured to receive the first user-inputs that define the sample size for each of the plurality of sampling constraints, wherein each sample size may be one of a percentage or a numerical value.

14. The computer program product of claim 10, wherein the computer-readable medium further comprises a sixth set of codes for causing a computer to receive a fifth user-input that defines a number of days between calibration trials.

15. The computer program product of claim 14, wherein the computer-readable medium further comprises a seventh set of codes for causing a computer to, based on the number of days between calibration trials expiring for an associate, automatically, and without knowledge of the associate, allocate a transaction performed by the associate to a general calibration queue in which the transaction is compared to a calibration standard.

16. The computer program product of claim 10, wherein the computer-readable medium further comprises a sixth set of codes for causing a computer to receive a fifth user-input that defines an auditor-specific sample size of the work process transactions that undergo quality assurance assessment by the auditor.

17. The computer program product of claim 10, wherein the computer-readable medium further comprises a sixth set of codes for causing a computer to receive fifth user-inputs that define, for an associate requiring process improvement, target values for (i) an overall quality score and (ii) individual work process parameters and an additional sample size of work process transactions performed by the associate that are to be quality assurance sampled.

18. The computer program product of claim 10, wherein the computer-readable medium further comprises a sixth set of codes for causing a computer to receive a fifth user-input that defines a process certification cycle for a specified work process.

19. A method for quality assurance assessment of a work process, the method comprising:
receiving, by a computing device processor, first user-inputs that define a sample size for each of a plurality of sampling constraints,
receiving, by a computing device processor, second user-inputs that select a time and date range for sampling completed work transactions from the work process,
receiving, by a computing device processor, third user-inputs that select one or more work queues from the work process to be sampled,
receiving, by a computing device processor, a fourth user-input that selects a sampling constraint from amongst the plurality of sampling constraints, and
automatically and randomly, determining, by a computing device processor, samples for quality assurance assessment in accordance with (i) the selected time and date range, (ii) the selected work queues, (iii) the selected sampling constraint and (iv) the selected sample size associated with the selected sampling constraint.

20. The method of claim 19, wherein receiving the first user-inputs further comprises receiving, by the computing device processor, the first user-inputs that define the sample size for each of the plurality of sampling constraints, wherein the sampling constraints include (i) an overall population of associates assigned to a work process, (ii) each associate for each work queue worked by a corresponding associate, (iii) each individual queue in the work process, and (iv) each individual associate assigned to the work process.
